(19) United States
(12) Patent Application Publication
(10) Pub. No.: US 2011/0132675 A1
(43) Pub. Date: Jun. 9, 2011

(54) Hybrid drive arrangement

(76) Inventor: Norbert Braun, Dettingen (DE)

(21) Appl. No.: 12/592,858

(22) Filed: Dec. 3, 2009

(51) Int. Cl. B60K 6/442

(52) U.S. Cl. 180/65.23; 180/65.21

(57) ABSTRACT

In a hybrid drive for a motor vehicle including a hybrid transmission with an operating mode shift device for shifting between at least one power-split operating mode and a parallel hybrid operating mode and with at least one planetary gear set, which has at least one first transmission element to be connected in the power-split operating mode to a first drive machine in a torque-proof manner and which has at least a second transmission element to be connected in a torque-proof manner in the power-split operating mode to a second drive machine, the operating mode shift device is adapted to connect the two drive machines in the parallel hybrid operating mode in the power train parallel to the first transmission element.

### BACKGROUND OF THE INVENTION

The invention relates to a hybrid drive arrangement, particularly for a motor vehicle, including at least a power split operating mode and a parallel hybrid operating mode and means for shifting between the various operating modes.

DE 10 2004 042 007 A1 discloses a hybrid transmission device having a power-split operating mode.

It is the principal object of the present invention to provide a hybrid drive arrangement with a transmission which reduces the costs of a hybrid vehicle by its simple and compact design.

### SUMMARY OF THE INVENTION

The invention resides in a hybrid drive arrangement, especially for a motor vehicle including a hybrid transmission with an operating mode shift device for optionally shifting between at least one power-split operating mode and a parallel hybrid operating mode, and at least one planetary gear set which has at least one first transmission element for connection to a first drive machine (engine) in a torque-proof manner in the power-split operating mode, and at least a second transmission element for connection to a second drive machine in the power-split operating mode.

It is suggested that the operating mode shift device is provided to connect at least the two drive machines parallel to the first transmission element in the power train. A broad palette of vehicle uses can be covered optimally by an operating mode shift device which can shift between a power-split operating mode and a parallel hybrid operating mode. A flexible number of transmission ratios and drive versions can be provided by the power-split operating mode and the parallel hybrid operating mode. A distribution of a necessary power on the two drive machines can be achieved by the connection in the parallel hybrid operating mode of the two drive machines in the power train parallel to the first transmission element. A simple design, especially of one of the drive machines, which is an internal combustion engine can be achieved, and energy losses can be avoided by the distribution of the necessary power required for driving the vehicle. Costs can be saved by a simple construction of the drive machine in the form of an internal combustion engine. “Connecting” in this context is especially intended to indicate a direct torque-proof connection, where the two drive machines are connected directly to the first transmission element in a torque-proof manner. Especially, a connection by means of shift units and shafts for the torque-proof connection is meant thereby. “Connect” is not meant for example to reside in a blocking of a planetary gear set. The operating mode shift device can, in addition to the power-split operating mode and the parallel hybrid operating mode, preferably also shift an electrical operating mode and an internal combustion engine operating mode. “Power-split operating mode” is especially meant to be an operating mode where a power of the two drive machines extends via at least two power paths. A “power path” is especially meant to be a path of power through the planetary gear set. The “parallel hybrid operating mode” is especially meant to be an operating mode where the two drive machines jointly drive a transmission element of a planetary gear set, as for example a sun wheel of a planetary gear set. The “electrical operating mode” is especially meant to refer to an operating mode where a necessary total power is provided alone by one or several drive machines operating as electric machines. Any drive machine in the form of internal combustion engine is preferably disengaged in the electrical operating mode. An “internal combustion engine operating mode” is especially meant to be an operating mode where the necessary total power is provided alone by one or several drive machines in the form of an internal combustion engine. The electric machine can basically convert electrical power into a drive torque and a drive torque into electrical power.

It is further suggested that the operating mode shift device has at least one shift unit, which is provided to connect the first drive machine and the first transmission element in a torque-proof manner. Thereby, a power generated by the first drive machine can be transferred to an output shaft via the first transmission element in a particularly simple manner. Such a “shift unit” is especially meant to be a unit having the capability to again disengage the components connecting the shift unit.

In an advantageous arrangement, the operating mode shift device has at least one shift unit which is provided to optionally connect the second drive machine to the first transmission element or the second transmission element in a torque-proof manner. Thereby, the power path generated by the second drive machine can be changed in an especially simple manner.

It is further suggested that the operating mode shift device has at least one shift unit which is provided to connect the second transmission element to a hybrid transmission housing in a torque-proof manner. A transmission element can thereby be fixed in an especially simple manner, whereby further operating modi or transmission ratios can be shifted in a simple manner.

It is further advantageous if the hybrid transmission has at least a third drive machine, which is provided in at least one operating state to directly supply one of the drive machines. A storage device which is provided for supplying a drive machine in the form of an electric machine with electric energy, can thereby have smaller dimensions. The third drive machine is preferably formed as an electrical drive machine. An electric drive machine can basically convert an electrical power to a drive torque, and a drive torque to electrical power. The third drive machine is especially formed as an electric machine. “Directly supply the drive machine” is especially to indicate that electrical energy is used for supplying the drive machine directly without conversion, especially in a chemical energy within a battery. The drive machine can in principal also be supplied indirectly via the electric machine. “Indirect” is especially meant to be a supply where the electrical power is at least stored intermediately in a storage device. “Storage device” is especially meant to indicate a device having the capability to store electrical energy and to output electrical power. The storage device comprises preferably a battery or several batteries.

It is further suggested that the hybrid transmission device has at least two axially arranged planetary gear sets with respectively at least one planetary wheel in series. It is especially suggested thereby that the hybrid transmission device has at least one planetary wheel shaft, on which are arranged the at least two planetary wheels arranged axially in series of the at least two planetary gear sets in a torque-proof manner. Components, installation space, weight, installation effort and costs can be saved thereby. A large number of shift versions can further be realized in a simple manner. The planetary gear sets are preferably arranged coaxially to one another, especially directly in series in the axial direction. Further, at least three planetary gear sets arranged axially in series are provided in an especially advantageous manner.

An arrangement of a hybrid transmission, which has at least two planetary gear sets arranged axially in series with respectively at least one planetary wheel and a planetary wheel shaft, on which the at least two axially planetary wheels of the planetary gear sets arranged axially in series are arranged in a torque-proof manner, can thereby in principal be used independently. It is combined with a hybrid transmission device in a particularly advantageous arrangement.

It is especially advantageous if the hybrid transmission has a transmission element in which includes at least one planetary wheel shaft. A rotation of at least two planetary wheels around the first transmission element can thereby be used in a particularly simple manner. The at least one planetary wheel shaft is advantageously mounted in the transmission element in a rotatable manner.

It is further advantageous if the transmission element is formed as a planetary wheel carrier, whereby a particularly compact arrangement can be achieved. As the planetary wheels of the respective planetary gear sets are arranged in a torque-proof manner on at least one planetary wheel shaft and the at least one planetary wheel shaft is mounted in the transmission, the rotational speed corresponds to a revolution movement of the planetary wheels around the associated sun wheels of the rotational speed of the transmission element.

It is further suggested that at least one of the planetary gear sets is an output planetary gear set and has at least one transmission element which is provided to be connected to an output shaft in a torque-proof manner. A simple set of gear wheels can thereby be realized for the hybrid transmission device. The at least one transmission element is preferably formed as the sun wheel of the at least one planetary gear set and cogs with the at least one planetary wheel of the corresponding planetary gear set.

It is further suggested that the hybrid transmission device has a gear shift device with at least one shift unit, which is provided to connect at least one of the transmission elements to an output shaft in a torque-proof manner. Transmission ratios can thereby be shifted in an especially simple manner.

It is particularly advantageous if the hybrid transmission device has at least one shift unit shifting with a positive fit. A high efficiency of the hybrid transmission device can be achieved thereby, especially if the operating mode shift device and the gear shift device have at least one shift unit shifting with a positive fit, and especially if all shift units of the operating mode shift device and the gear shift device are formed shifting with a positive fit. At least one shift unit is in the form of a claw coupling.

It is especially advantageous if the hybrid transmission has a synchronizing device which is provided to synchronize the at least one shift unit by means of at least one of the drive machines. A “synchronizing device” in this case is specifically a device comprising a control and/or regulation unit, and especially has a computing unit including a storage unit with a stored operating program and a processor. An advantageous shift process, especially with shift units formed as shifting with a positive fit can be arranged with a corresponding arrangement.

It is further advantageous if all shift units of the hybrid transmission device are shift units shifting with a positive fit. A hybrid transmission device with a particularly high efficiency can be provided thereby.

Further, a drive device with a hybrid transmission according to the invention and an electric drive machine unit and an internal combustion drive machine unit, which have at least essentially the same maximum power, is suggested. An electric machine drive unit is meant to be a unit with one or several electrical drive machines, and an internal combustion engine drive machine unit is meant to be a unit with one or several internal combustion engines. An “essentially the same maximum power” in this connection is meant to be especially that the maximum powers or nominal powers differ by less than 20%, preferably less than 10% of the total maximum drive power or nominal power. A particularly advantageous design of the individual drive machines can be achieved by a corresponding arrangement.

The invention will become more readily apparent from the following description of preferred embodiments thereof with reference to the accompanying drawings.

### BRIEF DESCRIPTION OF THE DRAWINGS

FIG. 1 shows a hybrid drive arrangement with a transmission according to the invention,

FIG. 2 shows a shift table of the hybrid transmission,

FIG. 3 shows rotational speed progressions for an exemplary acceleration process of the hybrid drive arrangement in the form of a diagram,

FIG. 4 shows an alternative design of the hybrid drive arrangement, and

FIG. 5 shows a further alternative design of the hybrid drive arrangement.

### DESCRIPTION OF PARTICULAR EMBODIMENTS

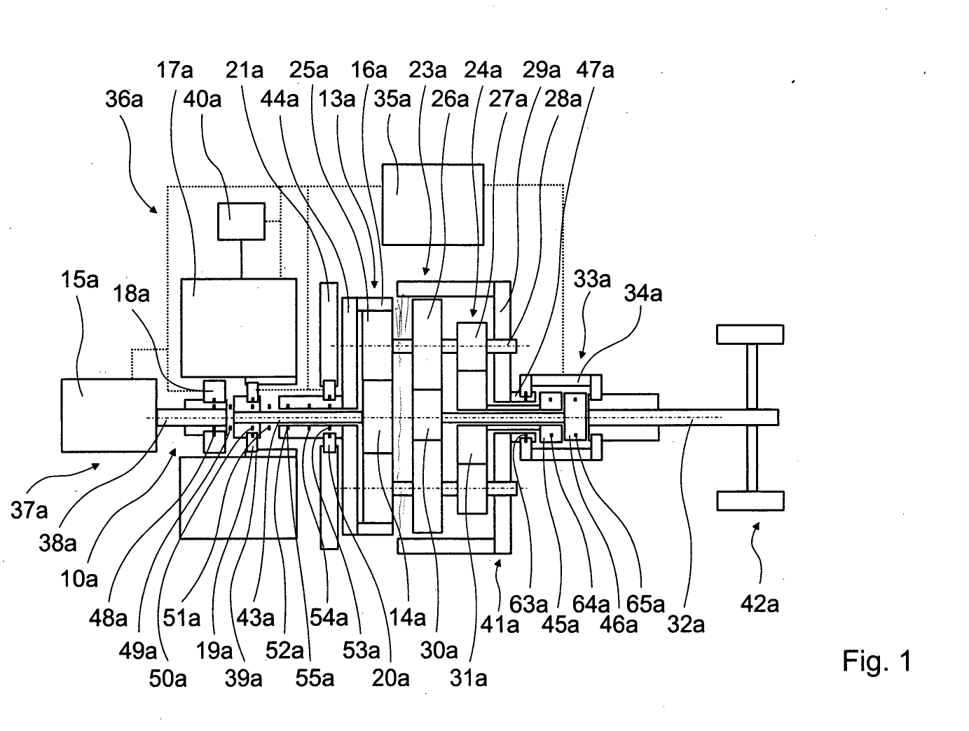

FIGS. 1 to 3 schematically show a drive arrangement according to the invention. The drive arrangement comprises an internal combustion engine drive machine unit 37a, an electric drive machine unit 36a and a hybrid transmission.

The hybrid transmission is incorporated in a motor vehicle hybrid drive arrangement. The internal combustion engine drive machine unit 37a comprises a first drive machine 15a which is the internal combustion engine. The electric drive machine unit 36a comprises a second drive machine 17a. The hybrid transmission is connected to the first drive machine 15a and the second drive machine 17a. The second drive machine 17a is in the form of an electric machine. The first drive machine 15a and the second drive machine 17a essentially have the same nominal power rating, that is, both can provide the same maximum drive power.

The hybrid transmission device comprises two drive shafts or sleeves 38a, 39a. The two drive shafts 38a, 39a are arranged coaxially to one another. The first drive machine 15a is connected to the drive shaft 38a in a torque-proof manner. The second drive machine 17a is connected to the drive shaft 39a in a torque-proof manner. The drive shaft 38a is driven directly by the first drive machine 15a. The drive shaft 39a is driven directly by the second drive machine 17a.

The hybrid transmission has a storage device 40a for storing an energy supply for the second drive machine 17a. The storage device 40a is an electrical energy storage. The storage device 40a can for example in principle be constructed of several interconnected batteries. Other electrical energy storages as for example capacitive energy storages are however also feasible in principle. The drive machine 17a in the form of an electric machine can thereby in principle be operated as a generator operation or as an electric motor in connection with the storage device 40a.

The hybrid transmission has a set of gear wheels 41a for the transmission of a torque. The set of gear wheels 41a comprises a first planetary gear set 13a, a second planetary gear set 23a, and a third planetary gear set 24a. The first planetary gear set 13a, the second planetary gear set 23a and the third planetary gear set 24a are arranged axially in series. They are aligned in a coaxial manner to one another. The first planetary gear set 13a is formed as a simple planetary wheel set. The second planetary gear set 23a and the third planetary gear set 24a are formed as sets of spur gears. The set of gear wheels 41a thus comprises a simple planetary wheel set with two integrated sets of spur gear.

The first planetary gear set 13a is arranged on the transmission input end and the third planetary gear set 24 is arranged at the transmission output end. The second planetary gear set 23a is arranged between the first planetary gear set 13a and the third planetary gear set 24a. The first planetary gear set 13a, the second planetary gear set 23a and the third planetary gear set 24a are connected downstream in a power train of the first drive machine 15a and the second drive machine 17a. The hybrid transmission comprises an output shaft 32a arranged downstream of the set of gear wheels 41a in a power train for outputting a drive power or a torque. The output shaft 32a is provided for the connection of drive wheels 42a.

The first planetary gear set 13a is formed as a drive planetary gear set. The first planetary gear set 13a has two transmission elements 14a, 16a, via which a torque outputted by the drive machines 15a, 17a in an operating state is guided to the planetary gear set 13a and thus to the set of gear wheels 41a. The first transmission element 14a of the first planetary gear set 13a is a sun wheel of the planetary gear set 13a. The second transmission element 16a of the first planetary gear set 13a is a hollow wheel of the planetary gear set 13a. The two transmission shafts 14a, 16a are arranged coaxially to one another. The planetary gear set 13 further comprises several planetary wheels 25, which are arranged between the first transmission element 14a and the second transmission element 16a. In the drawings, only one of the planetary wheels is provided with the reference numeral 25a. The planetary wheels 25a respectively cog with the transmission element 14a which is the sun wheel and with the transmission element 16a which is the hollow wheel.

For the connection of the drive machines 15a, 17a to the two transmission elements 14a, 16a of the first planetary gear set 13a, the hybrid transmission device comprises two drive machine connection elements 43a, 44a. The first drive machine connection element 43a is connected to the transmission element 14a of the first planetary gear set 13a forming the sun wheel in a torque-proof manner. The second drive machine connection element 44a is connected to the transmission element 16a of the first planetary gear set 13a forming the hollow wheel in a torque-proof manner. The second drive machine connection element 44a is formed as a hollow wheel through which the first drive machine connection element 43a extends.

The second planetary gear set 23a and the third planetary gear set 24a are output planetary gear sets. For the output of the torque inputted to the set of gear wheels 41a, the two planetary gear sets 23a, 24a respectively comprise a transmission element 30a, 31a. The transmission element 30a of the second planetary gear set 23a and the transmission element 31a of the third planetary gear set 24a are sun wheels of the planetary gear sets 23a and, respectively, 24a. The planetary gear sets 23a, 24a respectively comprise further planetary wheels 26a, 27a. The planetary wheels 26a of the second planetary gear set 23a cog with the transmission element 30a of the second planetary gear set 23a which is a sun wheel. The planetary wheels 27a of the third planetary gear set 24a cog with the transmission element 31a of the third planetary gear set 24a which is a sun wheel. In the drawings, only one of the planetary wheels is provided with the corresponding reference numeral 26a, 27a.

The planetary wheels 25a, 26a, 27a of the planetary gear sets 13a, 23a, 24a are respectively arranged in a coaxial manner. All planetary gear sets 13a, 23a, 24a have the same number of planetary wheels 25a, 26a, 27a. In the shown embodiment with several planetary wheels 25a, 26a, 27a per planetary gear set 13a, 23a, 24a, exactly one planetary wheel 26a of the planetary gear set 23a and exactly one planetary wheel 27a of the planetary gear set 24a is associated with each planetary wheel 25a of the planetary gear set 13a.

The respectively coaxially arranged planetary wheels 25a, 26a, 27a are connected in a in a torque-proof manner. For the torque-proof connection of the three planetary wheels 25a, 26a, 27a arranged in series in the axial direction of the three planetary gear sets 13a, 23a, 24a, the hybrid transmission device has planetary wheel shafts 28a. The three planetary wheels 25a, 26a, 27a arranged in series in the axial direction are arranged on the associated planetary wheel shaft 28a in a torque-proof manner.

For supporting the planetary wheel shaft 28a, the hybrid transmission device comprises a transmission element 29a, to which the planetary wheel shafts 28a are mounted in a rotatable manner. The transmission element 29a is arranged coaxially with the transmission elements 14a, 30a, 31a. The transmission element guides the planetary gear shafts 28a and thus the planetary wheels 25a, 26a, 27a on circular paths around the transmission elements 14a, 30a, 31a forming the sun wheels. The transmission element 29a is thereby a common planetary wheel carrier for the three planetary gear sets 13a, 23a, 24a. The transmission element 29a additionally encloses the second planetary gear set 23a and the third planetary gear set 24a and thus partially forms a housing for the set of gear wheels 41a.

The hybrid transmission device comprises the output shaft 32a for outputting a torque. The hybrid transmission device has three output shaft connection elements 45a, 46a, 47a for the torque-proof connection of the transmission elements 29a, 30a, 31a to the output shaft 32a. The output shaft connection element 47a is connected to the transmission element 29a which is a planetary wheel carrier in a torque-proof manner. The output shaft connection element 46a is connected to the transmission element 30a of the second planetary gear set 23a which is a sun wheel in a torque-proof manner. The output shaft connection element 45a is connected to the transmission element 31a of the third planetary gear set 24a that is a sun wheel in a torque-proof manner. The output shaft connection element 47a is a hollow shaft. The output shaft connection element 45a partially penetrates the output shaft connection element 47a. The output shaft connection element 45a includes also a hollow shaft. The output shaft connection element 46a extends through the output shaft connection element 45a and thus also through the output shaft connection element 47a.

The hybrid transmission device further comprises an operating mode shift device 10a. The operating mode shift device 10a optionally actuates an electrical operating mode 87a, a power-split operating mode 11a or a parallel hybrid operating mode 12a. For engaging the electrical operating mode 87a, the power-split operating mode 11a or the parallel hybrid operating mode 12a, the operating mode shift device 10a connects the drive machine connection elements 43a, 44a in dependence on the operating mode 11a, 12a, 87a to be shifted with the transmission elements 14a, 16a of the first planetary gear set 13a.

In the electrical operating mode 87a, the second drive machine 17a in the form of an electric machine is connected to the first transmission element 14a of the first planetary gear set in a torque-proof manner. The first drive machine 15a that is the internal combustion engine is disengaged from the first planetary gear set 13a in this operating mode.

In the power-split operating mode 11a, the first drive machine 15a that is the internal combustion engine is connected to the first transmission element 14a of the first planetary gear set 13a in a torque-proof manner. The second drive machine 17a which is an electric machine is connected to the second transmission element 16a of the first planetary gear set 13a in a torque-proof manner at the same time.

In the parallel hybrid operating mode 12a, the first drive machine 15a which is an internal combustion engine and the second drive machine 17a which is an electric machine are simultaneously connected to the transmission element 14a of the first planetary gear set 13a in a torque-proof manner. In this operating state, the two drive machines 15a, 17a are connected in parallel in the power train to the transmission element 14a of the first planetary gear set 13a that is a sun wheel.

The operating mode shift device 10a comprises three shift units for shifting the three operating modi. The shift units 18a, 19a, 20a are formed as a shift unit shifting with a positive fit. They are not synchronized. The first shift unit 18a, the second shift unit 19a and the third shift unit 20a are formed by means of claw couplings.

The first shift unit 18a of the operating mode shift device 10a has a first shift position 48a and a second shift position 49a. In the first shift position 48a of the first shift unit 18a, the first drive machine 15a is disengaged from the first drive machine connection element 43a and thus from the first planetary gear set 13a. In the second shift position 49a of the first shift unit 18a, the first shift unit 18a connects the drive shaft 38a of the first drive machine 15a to the first drive machine connection element 43a in a torque-proof manner and thus to the first transmission element 14a of the first planetary gear set 13a.

The second shift unit 19a of the operating mode shift device 10a has a first shift position 50a, a second shift position 51a and a third shift position 52a. In the first shift position 50a, the second shift unit 19a connects the drive shaft 39a of the second drive machine 17a to the first drive machine connection element 43a in a torque-proof manner and thus to the first transmission element 14a of the first planetary gear set 13a. In the second shift position 51a of the second shift unit 19a, the second shift unit 19a separates the second drive machine 17a from the first planetary gear set 13a. In the second shift position 51a of the second shift unit 19a, the second drive machine 17a is disengaged from the set of gear wheels 41a. In the third shift position 52a of the second shift unit 19a, the second shift unit 19a connects the drive shaft 39a of the second drive machine 17a to the sec- and drive machine connection element 44a and thus to the second transmission element 16a of the first planetary gear set 13a.

The third shift unit 20a of the operating mode shift device 10a has a first shift position 53a, a second shift position 54a and a third shift position 55a. In the first shift position 53a of the third shift unit 20a, the second drive machine connection element 44a and thus the second transmission element 16a of the first planetary gear set 13a is connected to a hybrid transmission housing 21a in a torque-proof manner. In the second shift position 54a of the third shift unit 20a, the third shift unit 20a separates the second drive machine connection element 44a from the hybrid transmission housing 21a. In the third shift position 55a, the third shift unit 20a connects the second drive machine connection element 44a to the second drive machine 17a in a torque-proof manner.

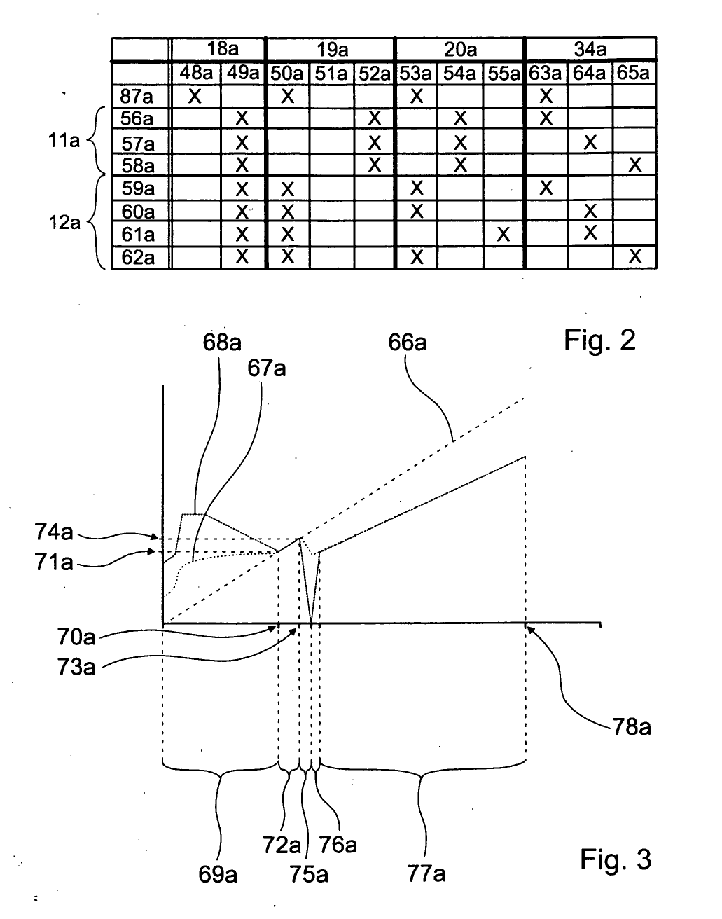

The hybrid transmission device also comprises a gear shift device 33a. The gear shift device 33a comprises a fourth shift unit 34a. The fourth shift unit 34a is a shift unit shifting with a positive fit. The shift unit 34a is not synchronized. The fourth shift unit 34a is a claw coupling. Three power-split drive regions 56a, 57a, 58a (FIG. 2) can be shifted by means of the gear shift device 33a in the power-split operating mode. A transmission ratio can be adjusted in a stepless manner in the drive regions 56a, 57a, 58a. Three defined transmission ratios 59a, 60a, 62a can be adjusted in the parallel hybrid operating mode 12a by means of the gear shift device 33a. A further defined transmission ratio 61a can be shifted by means of the gear shift device 33a and the third shift unit 20a of the operating mode shift device 10a in the parallel hybrid operating mode 12a.

The fourth shift unit 34a of the gear shift device 33a has a first shift position 63a, a second shift position 64a and a third shift position 65a. In the first shift position 63a of the fourth shift unit 34a, the fourth shift unit 34a connects the output shaft 32a to the first output shaft connection element 47a in a torque-proof manner and thereby to the transmission element 29a. In the second shift position 64a of the fourth shift unit 34a, the output shaft 32a is connected to the second output shaft connection element 45a in a torque-proof manner and thus to the transmission element 31a of the third planetary gear set 24a. In the third shift position 65a of the fourth shift unit 34a, the fourth shift unit 34a connects the output shaft 32a to the third output shaft connection element 46a in a torque-proof manner and thereby to the transmission element 30a of the second planetary gear set 23a.

All shift units 18a, 19a, 20a, 34a of the hybrid transmission device are formed as unsynchronized shift units shifting with a positive fit. The hybrid transmission device has an electronic synchronizing device 35a for synchronizing the shift units 18a, 19a, 20a, 34a. The synchronizing device 35a comprises a control and regulation unit, not shown in detail. The control and regulation unit controls or regulates the two drive machines 15a, 17a, the storage device 40a, the operating mode shift device 10a and the gear shift device 33a. A control of the operating mode shift device 10a and the gear shift device 33a takes place by means of automated shifting of the respective shift units 18a, 19a, 20a, 34a. The shift units 18a, 19a, 20a, 34a are actuated hydraulically. A mechanical and/or electrical actuation is also feasible in principle. The synchronizing device 35a synchronizes the shift units 18a, 19a, 20a, 34a by means of regulating the second drive machine 17a which is an electric machine.

In an operating state, in which the electrical operating mode 87a is shifted, the first shift unit 18a is in the first shift position 48a, the second shift unit 19a in the first shift position 50a, the third shift unit 20a in the first shift position 53a and the fourth shift unit in the first shift position 63a (see FIG. 2). The first transmission element 14a of the first planetary gear set 13a is only driven by the second drive machine 17a. As the second transmission element 16a of the first planetary gear set 13a is connected to the hybrid transmission housing 21a in a torque-proof manner, a rotational speed of the first output shaft connection element 47a which is a planetary carrier is defined by the rotational speed of the second drive machine 17a and a stationary transmission ratio of the first planetary gear set 13a. The output shaft 32a is driven by the first output shaft connection element 47a.

In an operating state, in which the power-split operating mode 11a is shifted, the first shift unit 18a is in its second shift position 49a, the second shift unit 19a in its third shift position 52a and the third shift unit 20a in its second shift position 54a. The first transmission element 14a of the first planetary gear set 13a is driven in the power-split operating mode 11a via the first drive machine 15a, and the second transmission element 16a of the first planetary gear set via the second drive machine 17a. The first drive region 56a, the second drive region 57a or the third drive region 58a is chosen by means of the gear shift device 33a. By a corresponding regulation of the second drive machine 17a, the transmission ratio of the set of gear wheels 41a is adjusted in the power-split operating mode 11a.

For shifting the first drive region 56a, the fourth shift unit 34a is shifted to its first shift position 63c. The output shaft 32a is driven by the first output shaft connection element 47a. A rotational speed of the transmission element 29a and thus of the output shaft connection element 47a is defined by a rotational speed of the first transmission element 14a of the first planetary gear set 13a driven by the first drive machine 15a, a rotational speed of the second transmission element 16a of the first planetary gear set 13a driven by the second drive machine 17a and the transmission ratio of the first planetary gear set 13a.

For shifting the second power-split drive region 57a, the fourth shift unit 34a is shifted to its second shift position 64a. The output shaft 32a is driven via the second output shaft connection element 45a. A rotational speed of the transmission element 31a and thus of the second output shaft connection element 45a is defined by a rotational speed of a transmission element 29a which is planetary wheel carrier and a rotational speed of the planetary wheels 27a and the transmission ratio of the third planetary gear set 24a. The rotational speed of the planetary wheels 27a and the rotational speed of the transmission element 29a are defined by the rotational speed of the first drive machine 15a and the rotational speed of the second drive machine 17a.

For shifting the third power-split drive region 58a, the fourth shift unit 34a is shifted to its third shift position 65a. The output shaft 32a is driven by the third output shaft connection element 46a. A rotational speed of the transmission element 30a and thus of the output shaft connection element 46a is defined by a rotational speed of the transmission element 29a formed as a planetary wheel carrier and a rotational speed of the planetary wheels 26a and the transmission ratio of the second planetary gear set 23a. The rotational speed of the planetary wheels 26a and the rotational speed of the transmission element 29a are defined by the rotational speed of the first drive machine 15a and the rotational speed of the second drive machine 17a.

In an operating state, in which the parallel hybrid operating mode 12a is shifted, the first shift unit 18a is in its second shift position 49a and the second shift unit 19a in its first shift position 50a. In the parallel hybrid operating mode 12a, the first drive machine 15a, and the second drive machine 17a are connected in parallel in the power train to the first transmission element 14a of the first planetary gear set by means of the operating mode shift device 10a. In the parallel hybrid operating mode 12a, the first transmission element 14a of the first planetary gear set 13a is driven together by the first drive machine 15a and the second drive machine 17a. The rotational speed of the first drive machine connection element 43a and the rotational speed of the second drive machine connection element 44a or the rotational speeds of the drive machines 15a, 17a are thus essentially always the same. The four transmission ratios 59a, 60a, 61a, 62a of the parallel hybrid operation mode 12a can be shifted by means of the third shift unit 20a and the fourth shift unit 34a.

For shifting the fourth transmission ratio 59a, the third shift unit 20a is shifted to its first shift position 53a and the fourth shift unit 34a to its third shift position 63a. The output shaft 32a is thereby connected to the first output shaft connection element 47a in a torque-proof manner. As the second transmission element 16a of the first planetary gear set 13a is connected to the hybrid transmission housing 21a in a torque-proof manner, the rotational speed of the transmission element 29a and thus the rotational speed of the output shaft connection element 47a is defined by the rotational speed of the drive machine 15a, 17a and the fixed transmission ratio of the first planetary gear set 13a.

For shifting the second transmission ratio 60a, the third shift unit 20a is shifted to its first shift position 53a and the fourth shift unit 34a to its second shift position 64a. The output shaft 32a is thereby connected to the second output shaft connection element 45a in a torque-proof manner. As the second transmission element 16a of the first planetary gear set 13a is connected to the hybrid transmission housing 21a in a torque-proof manner, the rotational speed of the planetary wheels 27a and the rotational speed of the transmission element 29a is defined by the rotational speed of the drive machines 15a, 17a. The rotational speed of the transmission element 30a and thus the rotational speed of the output shaft connection element 45 is defined by the transmission ratio of the third planetary gear set 24a.

For shifting the third transmission ratio 61a, the third shift unit 20a is shifted to its third shift position 55a and the fourth shift unit 34a to its second shift position 64a. The output shaft 32a is thereby connected to the second output shaft connection element 45a in a torque-proof manner. The rotational speed of the transmission element 31a and thus the rotational speed of the output shaft connection element 45a is defined by the rotational speed of the transmission element 29a formed as planetary wheel carrier. As the two transmission elements 14a, 16a of the first planetary gear set are connected in a torque-proof manner, the first planetary gear set is blocked and the rotational speed of the planetary wheels 25a, 26a, 27a are equal to zero relative to the transmission element 29a. The rotational speed of the transmission element 31a is thereby also the same as the rotational speed of the drive machines 15a, 17a. The third transmission ratio 61a forms a direct gear. For shifting the third transmission unit 61a, it is also feasible in principle to shift the fourth shift unit 34a to its first shift position 63a or its third shift position 65a.

For shifting the fourth transmission ratio 62a, the third shift unit 20a is shifted to its first shift position 53a and the fourth shift unit 34a to its third shift position 65a. The output shaft 32a is thereby connected to the third output shaft connection element 46a in a torque-proof manner. As the second transmission element 16a of the first planetary gear set 13a is connected to the hybrid transmission housing 21a in a torque-proof manner, the rotational speed of the planetary wheels 26a and the rotational speed of the transmission element 29a is defined by the rotational speed of the second drive machines 15a, 17a. The rotational speed of the transmission element 30a and thus the rotational speed of the output shaft connection element 46a is defined by the transmission ratio of the second planetary gear set 23a.

An operating mode where only the first drive machine 15a is connected to the set of gear wheels 41a is also possible in principle. For this, the first shift unit 18a is shifted to its second shift position 49a and the third shift unit 20a to its first shift position 53a. The second drive machine 17a is thereby disengaged, by shifting the second shift unit 19a to the second shift position 51a. It is further also possible to shift the second drive machine 17a formed as an electric machine, especially in the parallel hybrid operating mode 12a, to a generator operation.

In an exemplary shift process, in which shifting takes place from the first step-less power-split drive region 56a to the first defined transmission ratio 59a, the synchronizing device 35a first regulates the second drive machine 17a to a rotational speed of zero and thereby synchronizes the second shift unit 19a and the third shift unit 20a. Then, the synchronizing device 35a shifts the third shift unit 20a from the second shift position 54 to the first shift position 53a and the second shift unit 19a from the third shift position 52a to the second shift position 51a. In the second shift position 51a of the second shift unit 19a, and thus with a disengaged second drive machine 17a, the synchronizing device 35a regulates or synchronizes the rotational speed of the second drive machine 17a to the rotational speed of the first drive machine 15a and thereby synchronizes the second shift unit 19a. In the last step, the synchronizing device 35a shifts the second shift unit 19a from the second shift position 51a to the first shift position 50a.

In an exemplary shift process, in which it is shifted from the first defined transmission ratio 59a to the second defined transmission ratio 60a, the synchronizing device 35a first shifts the second shift unit 19a from the first shift position 50a to the second shift position 51a and thus disengages the second drive machine 17a. Then, the synchronizing device 35a regulates the rotational speed of the second drive machine 17a to zero and thereby synchronizes the second shift unit 19a and the third shift unit 20a. With the rotational speed zero of the second drive machine 17a, the synchronizing device 35a shifts the second shift unit 19a from the second shift position 51a to the third shift position 52a and the third shift unit 20a from the first shift position 53a to the second shift position 54a. In a further step, the synchronizing device 35a synchronizes the fourth shift unit 34a to the rotational speed of the first drive machine 15a by means of the second drive machine 17a. With the same rotational speed of the first drive machine 15a and the second drive machine 17a, the synchronizing device 35a shifts the fourth shift unit 34a from the first shift position 63a to the second shift position 64a. Then, the synchronizing devices 35a regulates the second drive machine 17a to the rotational speed of zero and thereby synchronizes the second shift unit 19a and the third shift unit 20a. With the rotational speed zero of the second drive machine 17a, the synchronizing device 35a shifts the third shift unit 20a from the second shift position 54a to the first shift position 53a and the second shift unit 19a from the third shift position 52a to the second shift position 51a. Then, the synchronizing device 35a synchronizes the second shift unit 19a to the rotational speed of the first drive machine 15a by means of the second drive machine 17a. With the same rotational speed of the first drive machine 15a and the second drive machine 17a, the synchronizing device 35a shifts the second shift unit 19a from the second shift position 51a to the first shift position 50a.

FIG. 3 shows rotational speed progressions for an exemplary acceleration process from a vehicle standstill to a highest vehicle speed. In FIG. 3, a speed of the motor vehicle is drawn as the abscissa, and a rotational speed as ordinate. The progression of an output rotational speed can be taken from an output rotational speed characteristic 66a, the progression of the rotational speed of the first drive machine 15a can be taken from an internal combustion engine characteristic 67a, and the progression of the rotational speed of the second drive machine 17a can be taken from an electric engine characteristic 68a. A start-up of the motor vehicle takes place in the third drive region 58a of the power-split operating mode 11a. In a first region 69a, the motor vehicle is accelerated in the third stepless power-split drive region 58a to a speed 70a. With the speed 70a, the first drive machine 15a and the second drive machine 17a have the same rotational speed 71a. Now the synchronizing device 35a shifts to the third transmission ratio 61a formed as a direct gear. During a further acceleration in a region 72a, the third transmission ratio 61a is shifted. The rotational speeds of the first drive machine 15a and the second drive machine 17a are thus the same in this region 72a. In the region 72a, the motor vehicle accelerates in the third fixed transmission ratio 61a up to a speed 73a.

At the speed 73a and a rotational speed 74a, the synchronizing device 35a shifts again to the third power-split drive region 58a. In a region 75a following the rotational speed 73a, in which the vehicle accelerates further, the synchronizing device 35a synchronizes the set of gear wheels 41 for the shift of the fourth transmission ratio 62a. For this, the synchronizing device 35a reduces the rotational speeds of the two drive machines 15a, 17a at the same time, while the vehicle accelerates further. With a defined rotational speed of the second drive machine 17a, which is equal to zero in this embodiment, the synchronizing device 35a shifts the fourth transmission ratio 62a. Subsequently, the synchronizing device 35a disengages the second drive machine 17a from the set of gear wheels 41a.

The second drive machine 17a can then remain disengaged. In FIG. 3, the synchronizing device 35a synchronizes the rotational speed of the second drive machine 17a in a region 76a and therewith the second shift unit 19a to the updated rotational speed of the first drive machine 15a. As soon as the rotational speeds of the drive machines 15a, 17a are the same, the synchronizing device 35a shifts to the fourth transmission ratio 62a. In a region 77a, the motor vehicle is accelerated up to a maximum rotational speed 78a in the fourth transmission ratio 62a.

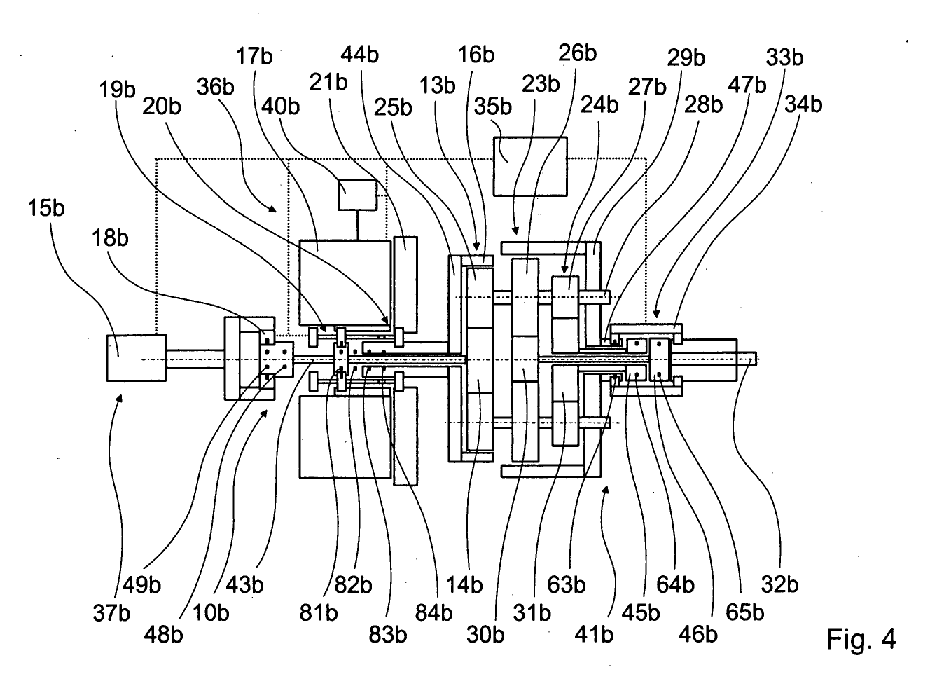

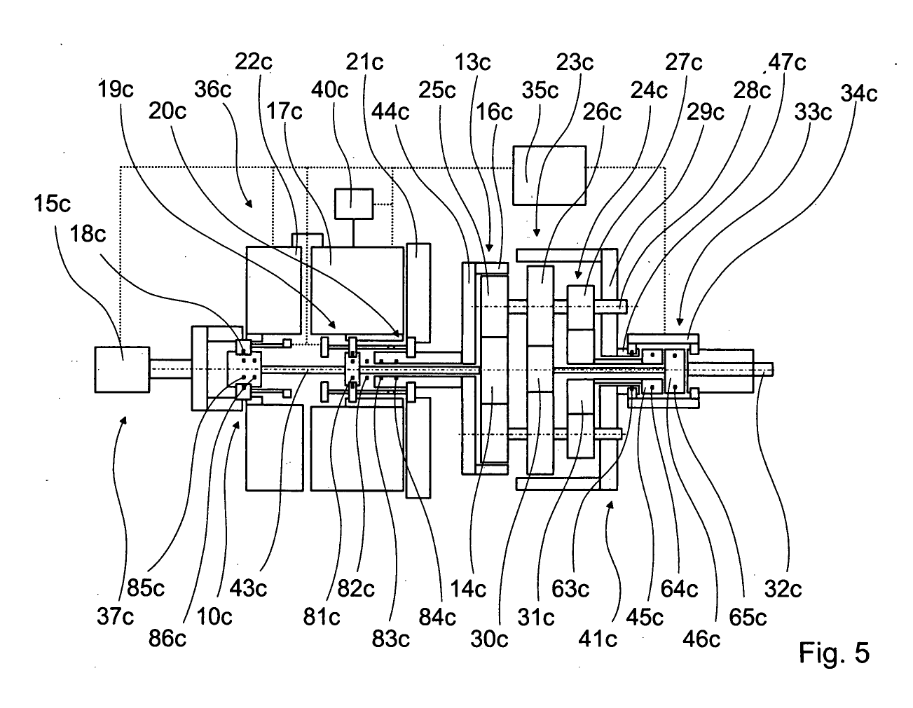

In FIGS. 4 and 5, two further embodiments of the invention are shown. For distinguishing the embodiments, the letter a in the reference numerals of the embodiment in FIGS. 1 to 3 is replaced by the letters b and c in the reference numerals of the embodiments in FIGS. 4 and 5. The following description is essentially limited to differences between the embodiments. With regard to components, characteristics and functions staying the same, one can refer to the description and/or the drawings of the embodiment in FIGS. 1 to 3 and/or the respective previous embodiments.

FIG. 4 shows a further embodiment of a drive device. The drive device comprises an internal combustion drive machine unit 37b, an electric drive machine unit 36b and a hybrid transmission. The hybrid transmission is a motor vehicle hybrid transmission. The internal combustion drive machine unit 37b comprises a first drive machine 15b. The electric drive machine unit 36b comprises a second drive machine 17b. The hybrid drive device is connected to the first drive machine 15b and the second drive machine 17b. The first drive machine 15b is an internal combustion engine. The second drive machine 17b is an electric machine. The first drive machine 15b and the second drive machine 17b have essentially same maximum power. The hybrid transmission comprises a storage device 40b forming an energy supply for the second drive machine 17b.

The hybrid transmission device has a set of gear wheels 41b for the transmission of a torque. The set of gear wheels 41b comprises three planetary gear sets 13b, 23b, 24b. The first planetary gear set 13b is formed as a simple planetary wheel set. The second planetary gear set 23b and the third planetary gear set 24b are formed as sets of spur gears. The first planetary gear set 13b comprises a first transmission element 14b which is a sun wheel and a second transmission element 16b which is a hollow wheel. The second planetary gear set 23b and the third planetary gear set 24b respectively comprise a transmission elements 30b, 31b in the form of a sun wheels. The second planetary gear set 23b and the third planetary gear set 24b are output planetary gear sets. The first planetary gear set 13b, the second planetary gear set 23b and a third planetary gear set 24b are arranged coaxially in series.

The hybrid transmission has a first drive machine connection element 43b for the torque-proof connection of the first transmission element 14b of the first planetary gear set 13b to the first drive machine 15b and/or to the second drive machine 17b. The hybrid transmission has a second drive machine connection element 44b for the torque-proof connection of the second transmission element 16b of the first planetary gear set 13b to the second drive machine 17b.

The hybrid transmission device includes planetary wheel shafts 28b for the torque-proof connection of planetary wheels 25b, 26b, 27b of the three planetary gear sets. The planetary wheels 25b, 26b, 27b of the planetary gear sets 13b, 23b, 24b are respectively arranged in sets in a coaxial manner. The coaxial planetary wheels 25b, 26b; 27b are arranged on the associated planetary wheel shaft 28b in a torque-proof manner. The planetary wheel shafts 28b are mounted rotatably in a transmission element 29b for connecting the planetary wheels 25b, 26b, 27b to an output shaft 32b. The transmission element 29b is formed as a common planetary wheel carrier of the three planetary gear sets 13b, 23b, 24b and guides the planetary wheels 25b, 26b, 27b on a circular path.

The hybrid transmission has an output shaft connection element 45b for the torque-proof connection of the transmission element 31b of the third planetary gear step 24b to the output shaft 32b. The hybrid transmission has an output shaft connection element 46b for the torque-proof connection of the transmission element 30b of the second planetary gear set 23b to the output shaft 32b. The hybrid transmission comprises an output shaft connection element 47b for the torque-proof connection of the transmission element 29b which is planetary wheel carrier.

The hybrid transmission further comprises an operating mode shift device 10b and a gear shift device 33b. The operating mode shift device 10b is adapted to shift an electrical operating mode 87b, a power-split operating mode 11b or a parallel hybrid operating mode 12b. For shifting the electrical operating mode 87b, the power-split operating mode 11b or the parallel hybrid operating mode 12b, the operating mode shift device 10b connects the first drive machine 15b and/or the second drive machine 17b to the first planetary gear set 13b in a torque-proof manner.

In the electrical operating mode 87b, the second drive machine 17b is connected to the first transmission element 14b of the first planetary gear set 13b. In the power-split operating mode 11b, the first drive machine 15b is connected to the first transmission element 14b of the first planetary gear set 13b and the sec- and drive machine 17b to the second transmission element 16b of the first planetary gear set 13b. In the parallel hybrid operating mode 12b, the first drive machine 15b and the second drive machine 17b are connected together in parallel in the power train to the first transmission element 13b of the first planetary gear set 13b.

Three power-split drive regions 56b, 57b, 58b can be shifted by means of the gear shift device 33b, and three defined transmission ratios 59b, 60b, 62b can be adjusted in the parallel hybrid operating mode 12 by means of the gear shift device 33b. The gear shift device 33b thereby optionally connects one of the operating elements 29b, 30b, 31b to the output shaft 32b in a torque-proof manner. A further defined transmission ratio 61b can be shifted by means of the gear, shift device 33b and the operating mode shift device 10b.

The operating mode shift device 10b and the gear shift device 33b comprise altogether four shift units 18b, 19b, 20b, 34b shifting with a positive fit. The operating mode shift device 10b has the shift unit 18b and the shift units 19b, 20b. The gear shift device 33b has the shift unit 34b. The shift units 18b, 19b, 20b, 34b are formed as claw couplings. The switching units 19b, 20b are coupled axially in a rigid manner in contrast to the previous embodiment. The two shift units 19b, 20b are partially formed in one piece. An actuation element, not shown in detail, is specifically formed a single piece for the two shift units 19b, 20b.

The hybrid transmission device has a synchronizing device 35b for synchronizing the shift unit 18b, the shift unit 19b, 20b and the shift unit 35c. The synchronizing device 35b has a control and regulation unit, not shown in detail. The synchronizing device 35b is provided to synchronize the shift units 18b, 19b, 20b, 34b shifting with a positive fit by means of the drive machines 15b, 17b.

In a first shift position 48b, the first shift unit 18b separates the first drive machine 15b from the first drive machine connection element 43b. In a second shift position, the first shift unit 18b connects the first drive machine 15b to the first drive machine connection element 43b in a torque-proof manner.

The shift units 19b, 20b are designed for different rotational speeds. The shift unit 19b and the shift unit 20b are connected axially rigidly to one another and can be rotated with respect to one another. The combined shift units 19b, 20b have four common shift positions 81b, 82b, 83b, 84b.

In the first shift position 81b, the shift unit 19b connects the second drive machine 17b to the first drive machine connection element 43b in a torque-proof manner. In this shift position, the shift unit 20b connects a hybrid transmission housing 21b to the second drive machine connection element 44b in a torque-proof manner and thus fixes the transmission element 16b.

In the second shift position 82b, the shift unit 19b separates the second drive machine 17b from the first drive machine connection element 43b and the second drive machine connection element 44b in the second shift position 82b. The shift unit 20b connects the second drive machine connection element 44b to the hybrid transmission housing 21b in a torque-proof manner. In the second shift position 82b of the second shift unit 19b, the second drive machine 17b is disengaged from the set of gear wheels 41b.

In the third shift position 83b, the second shift unit 19b connects the sec- and drive machine 17b to the first drive machine connection element 43b in a torque-proof manner and to the second drive machine connection element 44b in a torque-proof manner. In the fourth shift position 84b, the second shift unit 19b connects the second drive machine 17b to the second drive machine connection element 44b in a torque-proof manner and to the first drive machine connection element 43b in a torque-proof manner. In the third shift position 83b and the fourth shift position 84b the shift unit 20b is without effect.

The shift unit 34b has three shift positions 63b, 64b, 65b analogously to the previous embodiment. In the first shift position 63b, the third shift unit 34b connects the first output shaft connection element 47b to the output shaft 32b in a torque-proof manner. In the second shift position 64c, the third shift unit 34b connects the second output shaft connection element 45b, and in the third shift position 65b, the third output shaft connection element 46b to the output shaft 32b in a torque-proof manner.

FIG. 5 shows a third embodiment of a drive. The drive device comprises an internal combustion drive machine unit 37c, an electric drive machine unit 36c and a hybrid transmission. The hybrid transmission device is formed as a motor vehicle hybrid transmission. The internal combustion drive machine unit 37c comprises a first drive machine 15c. The electric drive machine unit 36c comprises a second drive machine 17c and a third drive machine 22c in contrast to the previous embodiment. The hybrid drive includes the first drive machine 15c, the second drive machine 17c and the third drive machine 22c. The first drive machine 15c is an internal combustion engine. The second drive machine 17c and the third drive machine 22c are electric machines.

The third drive machine 22c is designed for generator operation and motor operation. In the generator operation of the third drive machine, the third drive machine 22c directly supplies the second drive machine 17c with electrical power.

In the motor operation of the third drive machine 22c, the third drive machine 22c provides additional drive power. The first drive machine 15c and the second drive machine 17c have essentially the same maximum power output capability. The second drive machine 17c and the third drive machine 22c can in principle be designed in such a manner that the sum of their maximum power outputs essentially corresponds to the maximum power of the first drive machine 15c. The hybrid drive arrangement has a storage device 22c for supplying energy to the second drive machine 17c.

The hybrid transmission device has a set of gear wheels 41c for the transmission of a torque. The set of gear wheels 41c comprises three planetary gear sets 13c, 23c, 24c. The first planetary gear set 13c is formed as a simple planetary wheel set. The second planetary gear set 23c and the third planetary gear set 24c are sets of spur gears. The first planetary gear set 13c comprises a first transmission element 14c which is a sun wheel and a second transmission element 16c in the form of a hollow wheel. The second planetary gear set 23c and the third planetary gear set 24c respectively comprise a transmission element 30c, 31c forming a sun wheel. The second planetary gear set 23c and the third planetary gear set 24c are output planetary gear sets. The three planetary gear sets 13c, 23c, 24c are arranged coaxially in series with one another.

The hybrid transmission device has a first drive machine connection element 43c for the torque-proof connection of the first transmission element 14c of the first planetary gear set 13c to the first drive machine 15c, to the third drive machine 22c and/or to the second drive machine 17c. The hybrid transmission device has a second drive machine connection element 44c for the torque-proof connection of the second transmission element 16c of the first planetary gear set 13c to the second drive machine 17c.

The hybrid transmission has planetary wheel shafts 28c for the torque-proof connection of planetary wheels 25c, 26c, 27c of the three planetary gear sets 13c, 23c, 24c. The planetary wheels 25c, 26c, 27c of the planetary gear sets 13c, 23c, 24c are respectively arranged in sets in a coaxial manner. The respectively coaxially arranged planetary wheels 25c, 26c, 27c are arranged on the associated planetary wheel shaft 28c in a torque-proof manner. The planetary wheel shafts 28c are mounted rotatably in a transmission element 29c for connecting the planetary wheels 25c, 26c, 27c to an output shaft 32c. The transmission element 29c is formed as a common planetary wheel carrier of the three planetary gear sets 13c, 23c, 24c and guides the planetary wheels 25c, 26c, 27c on a circular path.

The hybrid transmission has an output shaft connection element 45c for the torque-proof connection of the transmission element 31c of the third planetary gear step 24c to an output shaft 32c. The hybrid transmission device has an output shaft connection element 46c for the torque-proof connection of the transmission element 30c of the second planetary gear step 23c to the output shaft 32c. The hybrid transmission device has an output shaft connection element 47c for the torque-proof connection of the transmission element 29c which is planetary wheel carrier.

The hybrid transmission device further comprises an operating mode shift device 10c and a gear shift device 33c. The operating mode shift device 10c is adapted to shift an electrical operating mode 87c, a power-split operating mode 11c or a parallel hybrid operating mode 12c. For shifting the electrical operating mode 87c, the power-split operating mode 11c or the parallel hybrid operating mode 12c, the operating mode shifting device connects the first drive machine 15c, the third drive machine 22c and/or the second drive machine 17c to the first planetary gear set 13c.

In the electrical operating mode 87c, the third drive machine 22c, and the second drive machine 17c are connected to the first transmission element 14c of the first planetary gear set 13c. In the power-split operating mode 11c, the first drive machine 15c and the third drive machine 22c are connected to the first transmission element 14c of the first planetary gear set 13c, and the second drive machine 17c to the second transmission element 16c of the first planetary gear set. In the parallel hybrid operating mode 12c, the first drive machine 15c, the third drive machine 22c and the second drive machine 17c are connected together parallel in the power train to the first transmission element 14c of the first planetary gear set 13c.

The third drive machine 22c is, during the engine operation in the electrical operating mode 87c (see FIG. 2, replace a” by “c”). The third drive machine 22c is in the generator operation in the power-split operating mode 11c and in the parallel hybrid operating mode 12c.

Three power-split driving regions 56c, 57c, 58c can be shifted by means of the gear shift device 33c. Three defined transmission ratios 59c, 60c, 62c can be adjusted in the parallel hybrid operating mode 12 by means of the gear shift device 33c. The gear shift device 33c thereby optionally connects one of the operating elements 29c, 30c, 31c to the output shaft 32c in a torque-proof manner. A further defined transmission ratio 61 can be shifted by means of the gear shift device 33c and the operating mode shift device 10c.

The operating mode shift device 10c and the gear shift device 33c comprise altogether four shift units 18c, 19c, 20c, 34c shifting in a positive engagement. The operating mode shift device 10c has the shift unit 18c and the shift units 19c, 20c. The gear shift device 33c has the shift unit 34c. The shift units 18c, 19c, 20c, 34c are in the form of claw couplings. The shift units 19c, 20c are coupled axially in a rigid manner in contrast to the first embodiment. The two shift units 19c, 20c may be formed in one piece. An actuation element, not shown in detail, is especially formed in one piece for the two shift units 19c, 20c.

The hybrid transmission device has a synchronizing device 35c for synchronizing the shift unit 18c, the shift unit 19c, 20c and the shift unit 35c. The synchronizing device 35c has a control and regulation unit, not shown in detail. The synchronizing device 35c is provided to synchronize the shift units 18c, 19c, 20c, 34c shifting with a positive fit by means of the drive machines 15c, 17c.

The first shift unit 18c has two shift positions 85c, 86c. In contrast to the first and second embodiment, the first shift unit 18c connects the first drive machine 15c, the third drive machine 22c and the first drive machine connection element 43c in a torque-proof manner. The third drive machine 22c operates as a generator in the first shift position 85c of the first shift unit 18c. In the second shift position 86c of the first shift unit 18c, the first shift unit 18c only connects the third drive machine 22c to the first drive machine connection element 43c. In the second shift position 86c of the first shift unit 18c, the third drive machine operates as an engine. The first shift unit 18c can in principle still have a third shift position. In the third shift position of the shift unit 18c, only the first drive machine 15c would be connected to the first drive machine connection element 43c in a torque-proof manner. The third drive machine 22c would be disengaged from the set of gear wheels 41c in the third shift position.

The shift units 19c, 20c are designed for different rotational speeds. The shift unit 19c and the shift unit 20c are connected axially in a rigid manner and can be rotated with regard to one another. The combined shift units 19c, 20c have four common shift positions 81c, 82c, 83c, 84c.

In the first shift position 81c, the shift unit 19c connects the second drive machine 17c to the first drive machine connection element 43c in a torque-proof manner. In this shift position, the shift unit 20c connects a hybrid transmission housing 21c to the second drive machine connection element 44c in a torque-proof manner and thus fixes the transmission element 29c.

In the second shift position 82c, the shift unit 19c separates the second drive machine 17c from the first drive machine connection element 43c and the second drive machine connection element 44c. The shift unit 20c connects the second drive machine connection element 44c in the second shift position 82c to the hybrid transmission housing 21c in a torque-proof manner. In the second shift position 82c of the second shift unit 19c, the second drive machine 17c is disengaged from the set of gear wheels 41c.

In the third shift position 83c, the second shift unit 19c connects the second drive machine 17c to the first drive machine connection element 43c and to the second drive machine connection element 44c in a torque-proof manner. In the fourth shift position 84c, the second shift unit 19c connects the second drive machine 17c to the second drive machine connection element 44c in a torque-proof manner. The shift unit 20c is without effect in the third shift position 83c and the fourth shift position 84c.

The third shift unit 34c has three shift positions 63c, 64c, 65c. In the first shift position 63c, the third shift unit 34c connects the first output shaft connection element 47c to the output shaft 32c in a torque-proof manner. In the second shift position 64c, the third shift unit 34c connects the second output shaft connection element 45c, and in the third shift position 65c the third output shaft connection element 46c to the output shaft 32c in a torque-proof manner.

Two different operating types can be adjusted in an operating state in which the electrical operating mode 87c is shifted. The two operating modes can in principle be combined with the different transmission ratios of the set of gear wheels 41c by means of the gear shift device 33c.

In the first operating mode of the electrical operating mode 87c, the first shift unit 18c is in its second shift position 86c and the second shift units 19c, 20c in their first shift position 81c. The shift unit 34c is thereby in its first shift position 63c. In the first operating mode of the electrical operating mode 87c, the first drive machine 15c is disengaged from the set of gear wheels 41c, and the second drive machine 17c and the third drive machine 22c together drive the first transmission element 14c of the first planetary gear set 13c. As the output shaft 32c is connected to the first output shaft connection element 47c in a torque-proof manner, and the second transmission element 16c of the first planetary gear set 13c is connected to the hybrid transmission housing 21c in a torque-proof manner, the rotational speed of the output shaft 32c is defined by the rotational speed of the second drive machine 17c or the third drive machine 22c and the fixed transmission ratio of the first planetary gear set 13c.

In the second operating mode of the electrical operating mode 87c, the first shift unit 18c is in its second shift position 86c and the second shift unit 19c in its fourth shift position 84c. The third shift unit 34c is thereby in its first shift position 63c. In the second operating mode of the electrical operating mode 87c, the first drive machine 15c is disengaged from the set of gear wheels 41c. The second drive machine 17c drives the second transmission element 16c of the first planetary gear set 13c in the second operating mode of the electrical operating mode 87c and the third drive machine 22c drives the first transmission element 14c of the first planetary gear set 13c. As the output shaft 32c is connected to the first output shaft connection element 47c in a torque-proof manner, the rotational speed of the output shaft 32c is defined by the rotational speed of the second drive machine 17c and the third drive machine and the transmission ratio of the first planetary gear set 13c.

What is claimed is:

1. A hybrid drive including drive machines (15a, 17a, 15b, 17b) and a hybrid transmission for a motor vehicle, said hybrid transmission having an operating mode shift device (10a; 10b; 10c) for shifting between at least one power-split operating mode (11a; 11b; 11c) and a parallel hybrid operating mode (12a; 12b; 12c), and including at least one planetary gear set (13a; 13b; 13c), which has at least one first transmission element (14a; 14b; 14c), which for connection to a first drive machine (15a; 15b; 15c) in the at least one power-split operating mode (11a; 11b; 11c) in a torque-proof manner, and which has at least a second transmission element (16a; 16b; 16c) for connection to a second drive machine (17a; 17b; 17c) in the power-split operating mode (11a; 11b; 11c) in a torque-proof manner, said operating mode shift device (10a; 10b; 10c) being adapted to connect in the parallel hybrid operating mode (12a; 12b; 12c) at least said two drive machines (15a, 17a; 15b, 17b; 15c, 17c, 22c) in the power train parallel to said first transmission element (14a; 14b; 14c).

2. The hybrid drive arrangement according to claim 1, wherein the operating mode shift device (10a; 10b; 10c) has at least one shift unit (18a; 18b; 18c), for connecting the first drive machine (15a; 15b; 15c) and the first transmission element (14a; 14b; 14c) in a torque-proof manner.

3. The hybrid drive arrangement according to claim 1, wherein the operating mode shift device (10a; 10b; 10c) has at least one shift unit (19a; 19b; 19c), for connecting the second drive machine (17a; 17b; 17c) to the first transmission element (14a; 14b; 14c) or to the second transmission element (16a; 16b; 16c) in a torque-proof manner.

4. The hybrid drive arrangement according to claim 1, wherein the operating mode shift device (10a; 10b; 10c) has at least one shift unit (20a; 20b; 20c), for connecting the second transmission element (16a; 16b; 16c) to a hybrid transmission housing (21a; 21b; 21c) in a torque-proof manner.

5. The hybrid drive arrangement according to claim 1 including at least a third drive machine (22c) for directly supplying power to the second drive machine (17c) in at least one operating mode.

6. The hybrid drive arrangement according to claim 1 including at least two planetary gear sets (13a, 23a, 24a; 13b, 23b, 24b; 13c, 23c, 24c) arranged axially in series with at least one planetary drive wheel (25a, 26a, 27a; 25b, 26b, 27b; 25c, 26c, 27c), comprising at least one planetary wheel shaft (28a; 28b; 28c), on which said at least two planetary wheels (25a, 26a, 27a; 25b, 26b, 27b; 25c, 26c, 27c) of the at least two planetary gear sets (13a, 23a, 24a; 13b, 23b, 24b; 13c, 23c, 24c) are arranged in series in the axial direction in a torque-proof manner.

7. The hybrid drive arrangement according to claim 6 including a transmission element (29a; 29b; 29c), in which said at least one planetary wheel shaft (8a; 28b; 28c) is mounted.

8. The hybrid drive arrangement according to claim 7, wherein said transmission element (29a; 29b; 29c) is a planetary wheel carrier.

9. The hybrid drive arrangement according to claim 6, wherein at least one of the planetary gear sets (23a, 24a; 23b, 24b; 23c, 24c) is formed as an output planetary gear set and comprises at least one transmission element (30a, 31a; 30b, 31b; 30c, 31c) which is provided to be connected to an output shaft (32a; 32b; 32c) in a torque-proof manner.

10. The hybrid drive arrangement according to claim 7, including a gear shift device (33a; 33b; 33c) with at least one shift unit (34a; 34b; 34c) for connecting at least one of the transmission elements (29a, 30a, 31a; 29b, 30b, 31b; 29c; 30c, 31c) to an output shaft (32a; 32b; 32c) in a torque-proof manner.

11. The Hybrid transmission device according to claim 1 including at least one shift unit (18a, 19a, 20a, 34a; 18b, 19b, 34b; 18c, 19c, 34c) providing for shifting with a positive fit.

12. The hybrid drive arrangement according to claim 1, including a synchronizing device (35a; 35b; 35c), for synchronizing at least one shift unit (18a, 19a, 20a, 34a; 18b, 19b, 20b, 34b; 18c, 19c, 20c, 34c) by means of at least one of the drive machines (17a; 17b; 17c, 22c).

13. The hybrid drive arrangement according to claim 1, wherein all shift units (18a, 19a, 20a, 34a; 18b, 19b, 20b, 34b; 18c, 19c, 20c, 34c) are formed as shift units shifting with a positive fit.

14. The hybrid drive arrangement with a hybrid transmission according to claim 1 including an electric drive machine unit (36a; 36b; 36c) and an internal combustion engine (37a; 37b; 37c), which both have, at least essentially, the same maximum power output.

15. The hybrid drive arrangement with a hybrid transmission device according to claim 12 including a control unit (35a, 35b, 35c) controlling at least one drive machine (17a; 17b; 17c, 22c) for synchronizing at least one shift unit (18a, 19a, 20a, 34a; 18a, 19b, 20b, 34b; 18c, 19c, 20c, 34c).
